(19) United States
(12) Patent Application Publication
(10) Pub. No.: US 2005/0102243 A1
(43) Pub. Date: May 12, 2005

(54) Authorisation of online transactions

(76) Inventors: Cian Kinsella, Dublin (IE); Roger Martin, Dublin (IE)

Correspondence Address: JACOBSON HOLMAN PLLC, 400 SEVENTH STREET N.W., SUITE 600, WASHINGTON, DC, 20004, US

(21) Appl. No.: 10/661,619

(22) Filed: Sep. 15, 2003

Related U.S. Application Data
(63) Continuation of application No. PCT/IE02/00030, filed on Mar. 15, 2002.

(30) Foreign Application Priority Data
Mar. 16, 2001 (EP) EP01650028.2

(51) Int. Cl. G06F 17/60

(52) U.S. Cl. 705/67

(57) ABSTRACT

An authorisation system (2) is hosted by a financial institution to allow it to authorise transactions for customers having multiple users. Users of the customer can access an authorisation control model (4) to define transaction types according to conditions (11) and to define an authority state (10) associated with each transaction type. Each authority state (10) defines approval signatory sets and groups with Boolean AND and OR relationships to satisfy approval requirements.

### INTRODUCTION

1. Field of the Invention

The invention relates to authorisation of online transactions, particularly for customer organisations having multiple personnel who enter transactions.

2. Prior Art Discussion

At present many organisations have purchase order systems to control purchasing of goods or services from suppliers. Also, financial institutions (“banks”) have mandate systems which govern how transactions are to be authorised. For example, the mandate model will specify which of the customer organisation personnel should authorise transfer of funds from a deposit account A to a current account B.

However the above two systems operate in parallel, whereby the customer organisation purchase order system is of little benefit for authorising financial transactions and the banks mandate model is of little benefit for purchase ordering.

In the art, WO0057374 describes a system for authorisation for use of credit cards and purchasing at remote locations. It also describes a mechanism for managing credit cards and the requirements and message structures of credit card systems (e.g. VISANET). It relates to the case of single authorisation authorities. EP0745961A also relates to credit cards and allows only a single authorisation authority.

U.S. Pat. No. 5,500,513A relates to transactions requests coming from point of sale devices. U.S. Pat. No. 5,649,116A describes a system which allows authorisations by bank officers. This system is apparently intended for use by banks to manage the cash positions of customers, by combining available funds across groupings of accounts. U.S. Pat. No. 5,914,472A relates to merchant networks and credit card accounts offering only a single authorisation.

The above systems do not appear to provide both sufficient flexibility to allow different conditions for different transaction types and customers, and also comprehensive and strict transaction control.

It is therefore an object of the invention to provide a technical system to allow both banks and customer organisations to control authorisation of transactions in a versatile and comprehensive manner.

### SUMMARY OF THE INVENTION

According to the invention, there is provided a transaction authorisation system comprising means for authorising a transaction according to stored conditions and for interfacing with a transaction system, wherein
the authorisation system comprises an authorisation model having a plurality of authority states defining a plurality of required signatories for authorisation of a proposed transaction;
the system comprises means for allowing online user definition and updating of the model using user client systems; and
the system comprises means for receiving a request for a proposed transaction, for determining an applicable authority state, and for authorising the proposed transaction when sufficient signatory approvals have been received to satisfy the authority state.

In one embodiment, at least some authority states comprise a signatory group of signatory nodes, whereby all signatories of the group must approve.

In another embodiment, at least some authority states comprise a signatory set of signatory nodes, whereby any one signatory of the set must approve.

In a further embodiment, at least some authority states comprise a complex hierarchical structure of groups and sub-groups, the structure comprising at least three hierarchical levels.

In one embodiment, at least some authority states comprise a hierarchical structure of sets and sub-sets.

In another embodiment, each authority state is associated with a transaction type as defined by conditions.

In a further embodiment, the system comprises a template update interface comprising means for allowing users to update and define the conditions using a graphical display.

In one embodiment, said interface comprises means for allowing users to define the authority states using a graphical display.

In another embodiment, the system comprises means for storing a user-defined template for each association of conditions and authority state, for determining a relevant template for a proposed transaction if parameters of the proposed transaction satisfy the conditions, and for retrieving an authority state associated with the template.

In a further embodiment, the system comprises means for transmitting a notification to all signatories of a selected authority state, and for dynamically monitoring received responses to determine if the authority state is satisfied.

In one embodiment, the system further comprises means for downloading a wizard program via an encrypted connection to a user client system, the wizard program being for guiding a user through a process of defining the control model.

In another embodiment, the system comprises an online server for user access, said server comprising:—
a web channel for user control model definition; and
a channel manager for real time transaction execution.

In one embodiment, the web channel comprises an account list filter comprising means for building a list of allowable funding accounts associated with a user.

In another embodiment, the web channel further comprises a transaction type filter comprising means for building a list of allowable transaction types associated with a user.

In a further embodiment, the channel manager comprises an authorisation data manager comprising means for building look-up tables within objects by querying a rule database.

In one embodiment, the authorisation data manager comprises means for building said objects at the start of a user session and for caching said objects for processing of request by the user.

In another embodiment, the channel manager comprises an authorisation rule engine comprising means for querying the authorisation data manager to check if a proposed transaction meets transaction conditions, and for managing notification of signatures specified in the relevant authority state.

In a further embodiment, the system further comprises a role manager comprising means for:—
authenticating a user to determine a user identifier;
using the identifier to determine a plurality of roles associated with the user, said roles containing access level permission values;
building a role object comprising a combination of all of said role permission values; and
using said role object to control user access to the system during a session.

In one embodiment, said permissions comprise “enabled”, “excluded”, and “don't care” flags for a user for an access level.

In another embodiment, the role manager comprises means for combining the permission values with an excluded flag over-riding enabled flags.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a block diagram of an authorisation system of the invention;

FIG. 2 is a diagram of an authority state of the system;

FIG. 3 is a diagram illustrating customer condition editing;

FIG. 4 is a flow diagram illustrating process flow for transaction authorisation; and

FIG. 5 is a more detailed system diagram.

### DESCRIPTION OF THE EMBODIMENTS

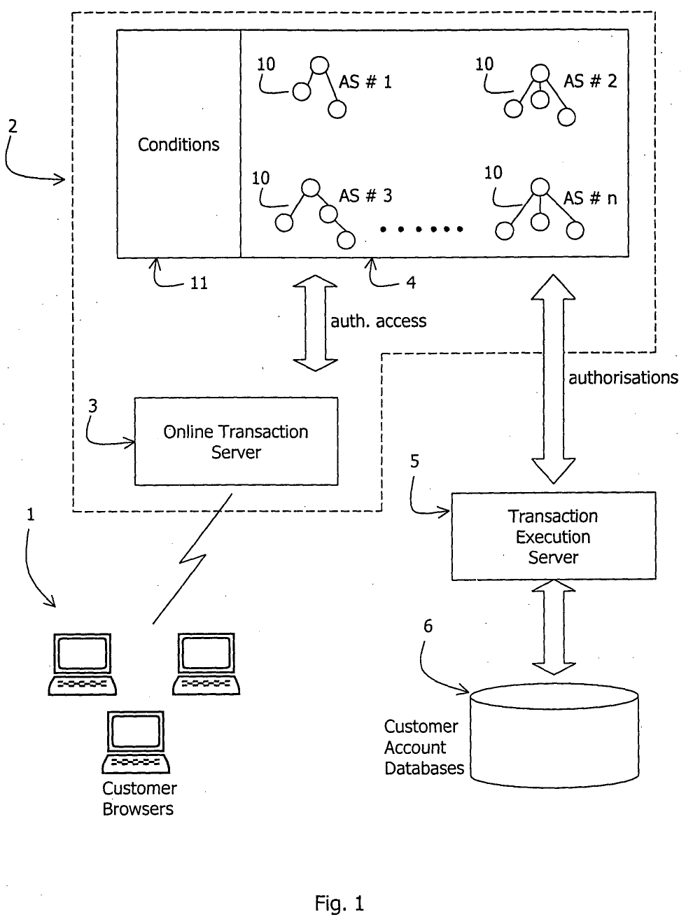

Referring to FIG. 1 user browsers 1 access a transaction control authorisation system 2 via an online transaction execution server 3. The users are part of a single corporate customer organisation having many users who are authorised for involvement with transactions executed by the bank on the customers behalf. The system 2 is in turn connected to a customer account database system 6 via a transaction server 5. The interaction between the browsers 1 and the model 2 is for both customer definition of transaction conditions and also for actual transaction execution. The system 2 allows a corporate customer to define the control model 4, and this is used by the bank to control execution of transactions. The system 2 thus effectively ties together the customer organisation purchasing policies and the bank's mandate policies in a very effective manner in the one system (2).

The transaction control model 4 comprises a number (n) of authority states (“AS”) 10 and transaction control conditions 11. Each AS 10 defines the customer personnel signatories required for approval of a type of transaction. The transaction type is defined by the conditions 11.

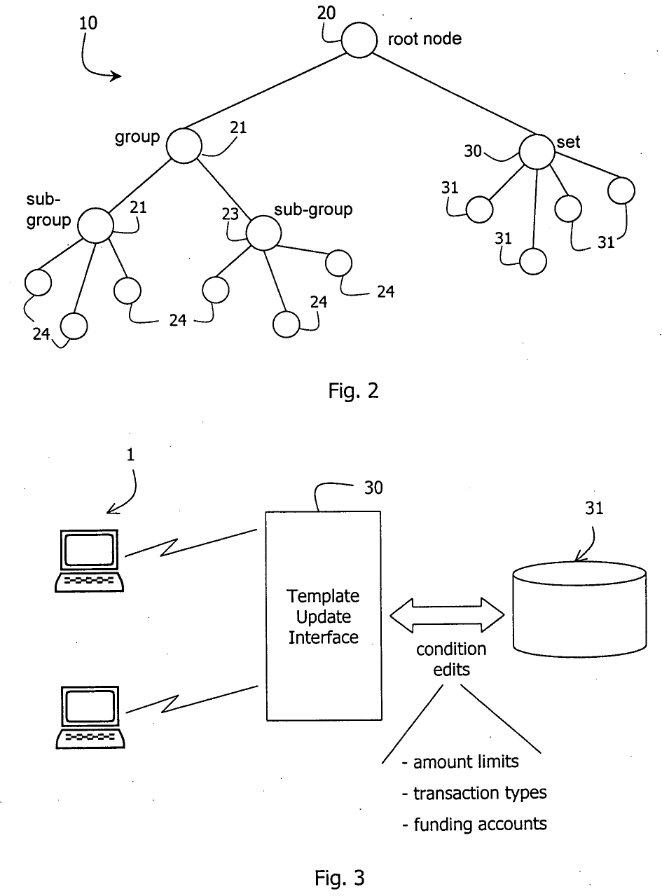

Referring to FIG. 2 an AS 10 comprises a hierarchical structure comprising a root node 20 and one or both of two types of dependent nodes, namely:
groups, and
sets.

A group has in turn at least one dependent signatory, and for authorisation all signatories of the group must authorise i.e. there is a Boolean AND relationship across the signatories of a group. On the other hand, a set has a least one dependent signatory only one of whom must authorise i.e. there is a Boolean OR relationship across the signatories. Sub-groups and sub-sets are also allowed. In the example of FIG. 2, there is a group 21 containing sub-groups 22 and 23, each containing nodes 24 for signatories. In this example there is one set 30, and this contains nodes 31 for signatories. Thus for authorisation of a transaction associated with the AS 10 illustrated in FIG. 2, all of the signatories 24 of the sub-groups 22 and 23 must approve, and only one of the signatories 31 of the set 30 must approve.

Referring to FIG. 3 the transaction server 3 executes a template update interface 30 which allows a user to define a set of conditions 11 associated with an authority state 10, and indeed the authority state itself where required. The template has a GUI for user definition of conditions 11 and authority states 10 and it links a set of conditions to an AS 10. The interface 30 allows users to define:—
account limit,
transaction type, and
funding account
   conditions 11 in a database 31 in the model 4. For a subsequent transaction request, the system 2 checks the requested transactions parameters against the defined conditions in order to select an AS 10. Once the AS 10 is selected it is used to seek approval.

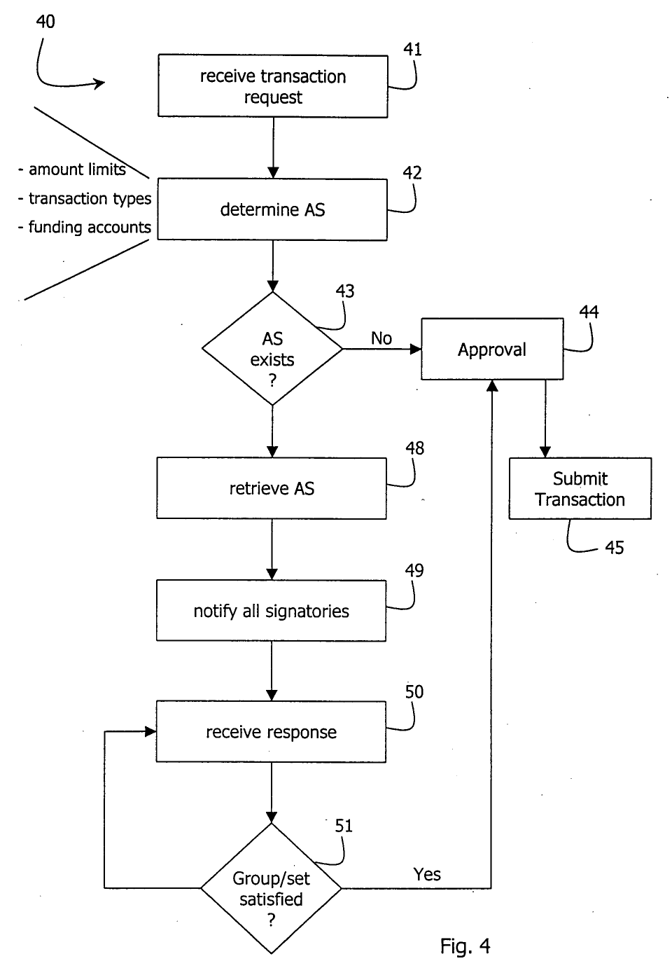

Referring to FIG. 4 an authorisation method 40 is described in more detail. In a step 41 a transaction request is received. In step 42 the processor uses parameters of the proposed transaction to execute the conditions (rules) to determine a relevant AS 10. Often the conditions will indicate that a particular user pre-defined AS 10 is applicable. However, in many cases the condition processing indicates that multiple authority states must be combined in a hierarchical structure, such as illustrated in FIG. 2. If no AS exists (decision step 43) there is immediate approval in step 44 and the transaction is submitted in step 45 to the transaction system 5.

However if an AS 10 exists (the requested transaction's parameters satisfy an account limit, transaction type, and funding account conditions), the AS 10 is retrieved in step 48. The system 2 then automatically transmits a notification to all signatories in step 49. Over time, responses are received to the notifications (step 50) and the system 2 dynamically monitors the responses to determine if all of the approvals required by the AS have been received. When the AS 10 is satisfied the transaction is approved.

Referring again to FIG. 3, definition of the conditions is performed very easily using a GUI and no programming expertise is required. Typically, an organisation will have a number of AS's pre-defined, and the user (supervisor) is only required to associate a set of conditions to one of these AS's. However a fresh AS may be defined by the user using the same GUI.

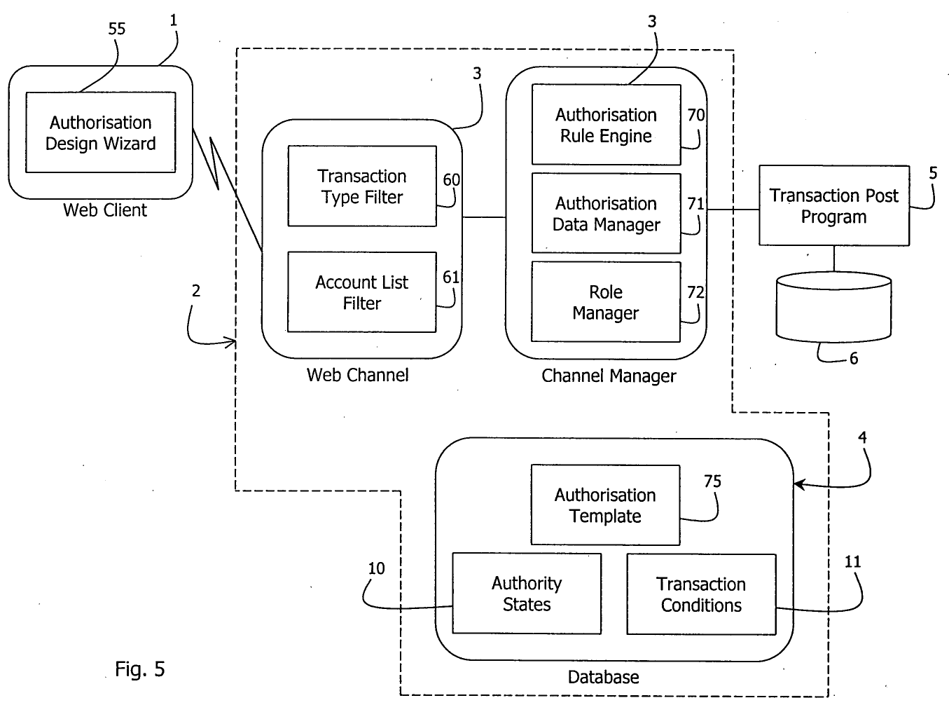

Referring to FIG. 5, the user client 1 executes a downloaded authorisation design wizard. This is dynamically downloaded where there has been update to it (server version is later than client version).

The authorisation system 2, in the online server 3 comprises:
a transaction type filter 60, an account list filter 61 for definition of the control model 4; and
an authorisation rule engine 70, an authorisation data manager 71, and a role manager 72 for real time transaction execution with use of the model 4.

The system 2 also comprises, in the control model 4, authorisation templates 75 linking authority states 10 with conditions 11.

In more detail, an authorisation design wizard (55) is a Java Applet downloaded via an SSL encrypted http connection as part of a user session. The user session has previously identified and authenticated the user through the use of digital certificate or an RSA SecureID, or a bank issued PIN number. On identifying the user, their user role is checked by the role manager 72 to see if they are entitled to manage the authorisation mechanism for the customer they belong to; if so they are offered the authorisation design wizard 55; if not, they are not. The authorisation design wizard 55 is downloaded to the user device 1, where the user may then configure the necessary authorisation rules either from scratch or based on existing templates. On configuration, the rules, (described in an XML structure) are transmitted back to the server 3 via an SSL encrypted http connection where they are stored in the model 4.

In building a transaction condition the user may define a set of funding accounts for which the authorisation rules are applicable. This list of funding accounts is built by the account list filter (61) in the server 3. It is necessary to filter the available accounts to allow bank business rules such as no payments allowed from fixed term deposit accounts to be implemented.

Likewise a transaction condition may define a set of transaction types for which the authorisation rules are applicable. This list of transaction types is built by the transaction list filter (60) in the server 3. It is necessary to filter the available transaction types to allow bank business rules such as no standing order mandates may be submitted to be implemented.

The filters allow the bank to define mandate processing parameters which then allows the customer to build the model 4 within the confines of how it manages its product set. The components 60, 61 and 55 operate exclusively in the definition of the model 4.

The components 70, 71, and 72 by being located in the channel manager, rather than the web channel of the server 3 allow the authorisation rules, though defined only over the web, to be applied to transaction requests coming from any managed channel such as WAP, ATM, POS, SMS or Web. The authorisation conditions 11 for a corporate organisation may be complicated, and though these are readily stored in the database, to allow all processing of these rules to be performed in the database would lead to a bottleneck and potentially low transaction throughput performance. Thus, the authorisation data manager 71 builds efficient lookup tables within C++ objects through SQL queries on the database. These C++ objects can be built at the start of a user session and cached for all processing of requests by the user. The authorisation rule engine 70 on receipt of a transaction request from any managed channel queries the authorisation data manager 71 to see if the request meets the transaction conditions 11 defined previously by the customer. The authorisation rule engine 70 notifies all necessary signatories, monitors their response, and on completion submits the transaction to the transaction post program of the back office (5).

The channel manager part of the server 3 comprises the role manager 72 for controlling user session initial connections in real time according to security criteria. This is both for model definition and for transaction execution interfacing. The role manager initially performs user authentication using a mechanism selected according to security requirements. For example the security mechanism may use simple password/username controls, full PKI mechanism, or voice or fingerprint biometrics authentication.

Once authentication is complete the role manager 72 has identified the user. The role manager 72 then determines from a look-up table the values for a number of roles, in this embodiment a user role, a customer role, and a customer type role. It then builds a role object having the various role values as attributes. These attributes comprise permissions in the form of “enabled”, “excluded”, and “don't care” flags for each data/system access level. In combining the permissions the role manager 72 uses an “excluded” permission value to override any number of “enabled” values for the same access level.

Thus, the role manager 72 provides an allowable set of access levels according to security requirements.

The system 2 allows banks the facility to enable their customers define and manage in an automated manner the authorisations required for the processing of transactions. To ensure the benefit is actually realised by the bank, customer concerns and fears of technology are overcome by providing a user intuitive graphical interface, as described below.

Definitions

A customer is a beneficiary owner of a set of accounts on a bank's back office system 5, 6. The users are individuals tied to a customer who are allowed to operate a subset of the customer's accounts. Each user is assigned a role that defines his/her rights and access levels to the subset of accounts. A user with an authorisation administration role is allowed to define the authorisation requirements for transaction requests submitted by other users of that customer.

Notification of Pending Requests

Users, on whose signature the transaction request is pending, are notified via a managed channel. A system channel manager manages the following channels
ATM Terminals
POS Terminals
Web Channel
WAP Channel
SMS Channel

When a user logs onto the system they are presented with a list of transaction requests pending their signature. On authorising the request the authority state is again checked and if the signatory conditions are met the transaction request is submitted to the back office for processing. Otherwise, it remains in the pending queue awaiting further authorisation.

Definition of Authorisation Rules by Administrator

The user with the role of authorisation administrator defines authorisation rules by setting values for the authorisation rule components itemised in the model. A transaction condition is created consisting of
An amount in a specified currency
A set of transaction request types
A set of accounts

This tri-part configuration of a transaction condition allows the administrator to target transactions of a certain value (such as all large transactions), or of a certain type (all overseas remittances) or for transactions from a set of accounts (day to day expenditure). These combinations allow the customer to create a fine-grained authorisation model that suits their exact business needs.

Definition of Authorisation Signatories

An authority state allows user signatory requirements to be defined by functional department or by rank, and allows complex hierarchies to be built. The definition of authority sets allows a quorum from specified groups to be used to satisfy an authorisation state. The definition of an authority state through the use of groups and sets allows complex hierarchical definitions to be defined that model how authorisation of transactions works in the real world. Some examples which are supported by this model are
Signed by three members of the board and the CEO
Signed by your manager, a member of the accounts division and a board member
Signed by the CFO and CEO or by five members of the board.

To process a transaction request, the requisite number of signatures are collected and stored on the channel database. Thus, a full and complete audit trail of all signatures to the transaction are kept.

Authorization Design Wizard 55

As described above, the authorisation design wizard is a Java Applet that is run within the browser on the client side, which allows the end-user through the familiar Microsoft Windows™ Standard style interface to easily devise corporate authorisation rules.

The wizard's interface presents three panels. A leftmost panel extends the length of the applet and allows the user to navigate through the authorisation concepts of
Signatories—Components of Authorisation Sets and Authorisation Groups
Transaction Conditions—Rules as to when authorisation is triggered
Authorisation Templates—Pre-built parameterised authorisation schemas

Another panel displays a visual representation of an authorisation schema. Another panel displays a Boolean logic representation of the authorisation schema.

Defining Signatory Groups

Signatory groups are created by navigating to a signatory section of the authorisation wizard, and selecting from a context menu “Create New Signatory Group”. Signatory groups may be renamed by editing in place in the navigation pane. A signatory group edit dialogue is displayed. This allows the definition of the group (assigned signatories) in terms of other groups (available signatories).

Defining Signatory Sets

As described above, signatory sets are OR relationships between signatories and signatory groups. The OR nature of this relationship allows the construction of quorums, where some pre-defined number of a group may make a binding decision for the group.

Signatory sets are created by navigating to an authorisation states section of the authorisation wizard, and by selecting from the context menu “Create New Signatory Set”. Signatory sets may be renamed by editing in place in the navigation panel. A signatory set edit dialogue appears. This allows the definition of a quorum within a group and of the addition of signatories and groups of signatories.

Defining Authority States

An authorisation state is an “AND” relationship between signatory groups and signatory sets that defines the full complement of signatories required for the processing of requests. An authority state is created by navigating to the authority state section and selecting from the context menu “Create Authority State” Authority states may be renamed by editing in place in the navigation panel. The authority state is constructed by adding members from authority groups and from authority sets into the state rule (bottom list).

Defining Transaction Conditions

Transaction conditions are template rules, defining what type of requests require authorisation before the request is processed. Transaction conditions are defined in terms of the main characteristics of a request, which are its funding account, its type and its amount. Transaction conditions are created by navigating to a transaction conditions section of the navigational panel and selecting from the context menu “Create New Transaction Conditions”. Transaction conditions may be renamed by editing in place in the navigational panel. A transaction condition edit dialog appears. This allows the selection of multiple funding accounts (from account), selection of multiple request types (transaction type) and the definition of the amount and the current the amount is expressed in.

Context Menu

A context menu is presented to the user in response to events in a navigational panel. Typically a mouse right button click causes the presentation of the context menu. The menu allows the deletion, creation and renaming of the selected item. It also offers a set of options to allow the creation of new items. Only the allowed items are shown, the others are disabled (indicated by the greying out of the menu items).

Definition of Template Parameters

The system 2 defines an authorisation template and can decide what parameters to leave blank. In one example, only a single parameter, signatory, is left blank. The customer can then select the template by navigating to an authorisation template section of the authorisation wizard, and by selecting the desired template are prompted for the blank parameters; in this case the identity of the required signatory.

Case Study

Dramatis Personae

WebWideBank—Internet Enabled financial institution using CR2 BankWorld as its Internet Channel
ClientsRus—Customer of WebWideBank that holds the following accounts
   DepositA—Demand Notice Savings Account (Used for Capital Expenditure)
   CurrentB—Current Account (Used for Day-to-day Expenditure)
   CurrentC—Current Account (Used for Marketing Expenses)
Alice—ClientsRus authorisation administrator
Bob—ClientsRus user who is ClientsRus IT Manager
Carol—ClientsRus user who is a ClientsRus IT Support Executive
Dave—ClientsRus user who is a ClientsRus Accountant
Edward—ClientsRus user who is a ClientsRus Sales Manager
Fiona—ClientsRus user who is a ClientsRus Director
Gerard—ClientsRus user who is a ClientsRus Sales Executive
Harriet—ClientsRus user who is a ClientsRus Director
   Scenario

ClientsRus is a large corporate whose auditors have raised concerns about their purchase order mechanism; their auditors main concerns was that although a PO system was in place it was more often ignored, and that ClientsRus had no mechanism in place that allowed the system to be enforced.

Happily for ClientsRus, their bankers WebWideBank have recently upgraded their Internet channel to use CR2's BankWorld that allows an automated PO system to be enforced on electronic transactions. ClientsRus signs up for this service, and the company secretary nominates Alice for the role of Authorisation Administrator.

Alice, on login to the web interface is presented with a Java design tool that allows her to create the PO rules as directed by the auditors. The rules created by Alice are . . .
1. Overseas Remittances for any amount from any account must be authorised by a ClientsRus Director
2. Domestic Transfers for any amount from any account must be authorised by a ClientsRus Manager
3. All transfers from DepositA for any amount must be authorised by Dave (the ClientsRus Accountant)
4. All transfers from any account for amounts greater than EUR5000 must be authorised by Dave and a ClientsRus Director
5. All transfers from CurrentC must be approved by a member of the Sales Team
6. All transfers from CurrentC over EUR2000 must be authorised by the Sales Manager

Carol is asked by her manager Bob to order a new colour laser printer costing USD 3000, and as it is capital expenditure to charge it to the DepositA accountant. The printer overseas vendor requires payment in full prior to delivery, so Carol logs onto the web to process the payment.

The exchange rate between USD and Euro when Carol inputs the payment is 1 USD=EUR1.14, so the transaction is for EUR3420. Carol submits the payment for processing. The transaction conditions are checked, and the authorisation rules triggered are
1 as the payment is an overseas remittance
3 as the payment is from the DepositA account

Carol is informed that she has insufficient authorisation to process this transaction, and Dave, Fiona and Harriet are all notified on their next login that there is a transaction pending their authorisation.

Harriet logs in before Fiona and authorises the payment, and sends a mail message to Dave, reminding him how important this colour printer is for the company and asking him to expedite the matter. Dave then digitally signs the transaction. When Fiona logs in, the pending transaction notification has been removed, as once Harriet signed the transaction, rule 1 was satisfied.

Once Dave signed the transaction it was submitted to the back office for processing; if there was insufficient funds in the account the transaction may still be rejected, but the ClientsRus PO system has now been implemented to their auditors' approval.

It will be appreciated that the invention allows comprehensive customer control over transaction authorisation in a very versatile manner. Bank staff do not need to ensure that the system is up to date or relevant to the customer: this happens under customer control. Thus, the problems of lack of synchronisation of bank mandate systems and customer purchase order systems is overcome.

The invention is not limited to the embodiments described but may be varied in construction and detail.

1. A transaction authorisation system comprising means for authorising a transaction according to stored conditions and for interfacing with a transaction system, wherein
the authorisation system (2) comprises an authorisation model (4) having a plurality of authority states (10) defining a plurality of required signatories for authorisation of a proposed transaction;
the system (2) comprises means for allowing online user definition and updating of the model (4) using user client systems; and
the system comprises means (3) for receiving a request for a proposed transaction, for determining an applicable authority state (10), and for authorising the proposed transaction when sufficient signatory approvals have been received to satisfy the authority state.

2. A transaction authorisation system as claimed in claim 1, wherein at least some authority states comprises a signatory group (21) of signatory nodes (24), whereby all signatories of the group must approve.

3. A transaction authorisation system as claimed in claim 1, wherein at least some authority states (10) comprise a signatory set (30) of signatory nodes (31), whereby any one signatory of the set must approve.

4. A transaction authorisation system as claimed in claim 2, wherein at least some authority states (10) comprise a complex hierarchical structure of groups and sub-groups, the structure comprising at least three hierarchical levels.

5. A transaction authorisation system as claimed in claim 3, wherein at least some authority states (10) comprise a hierarchical structure of sets and sub-sets.

6. A transaction authorisation system as claimed in claim 1, wherein each authority state (10) 's associated with a transaction type as defined by conditions (11).

7. A transaction authorisation system as claimed in claim 6, wherein the system (2) comprises a template update interface comprising means for allowing users to update and define the conditions using a graphical display.

8. A transaction authorisation system as claimed in claim 7, wherein said interface (30) comprising means for allowing users to define the authority states (10) using a graphical display.

9. A transaction authorisation system as claimed in claim 7, wherein the system (2) comprises means for storing a user-defined template for each associations of conditions (11) and authority state (10), for determining (42) a relevant template for a proposed transaction if parameters of the proposed transaction satisfy the conditions, and for retrieving an authority state (10) associated with the template.

10. A transaction authorisation system as claimed in claim 1, wherein the system comprises means for transmitting (49) a notification to all signatories of a selected authority state (10), and for dynamically monitoring (50) received responses to determine if the authority state is satisfied.

11. A transaction authorisation system as claimed in claim 1, wherein the system (2) further comprises means for downloading a wizard program (55) via an encrypted connection to a user client system (1), the wizard program (55) being for guiding a user through a process of defining the control model (4).

12. A transaction authorisation system as claimed in claim 1, wherein the system (2) comprises an online server (3) for user access, said server comprising:—
a web channel (60, 61) for user control model definition; and
a channel manager (70, 71, 72) for real time transaction execution.

13. A transaction authorisation system as claimed in claim 12, wherein the web channel comprises an account list filter (61) comprising means for building a list of allowable funding accounts associated with a user.

14. A transaction authorisation system as claimed in claim 12, wherein the web channel further comprises a transaction type filter (60) comprising means for building a list of allowable transaction types associated with a user.

15. A transaction authorisation system as claimed in claim 12, wherein the channel manager comprises an authorisation data manager (71) comprising means for building look-up tables within objects by querying a rule database.

16. A transaction authorisation system as claimed in claim 15, wherein the authorisation data manager (71) comprises means for building said objects at the start of a user session and for caching said objects for processing of request by the user.

17. A transaction authorisation system as claimed in claim 15, wherein the channel manager comprises an authorisation rule engine (70) comprising means for querying the authorisation data manager (71) to check if a proposed transaction meets transaction conditions, and for managing notification of signatures specified in the relevant authority state.

18. A transaction authorisation system as claimed in claim 17, wherein the system further comprises a role manager (72) comprising means for:—
authenticating a user to determine a user identifier;
using the identifier to determine a plurality of roles associated with the user, said roles containing access level permission values;
building a role object comprising a combination of all of said role permission values; and
using said role object to control user access to the system during a session.

19. A transaction authorisation system as claimed in claim 18, wherein said permissions comprise “enabled”, “excluded”, and “don't care” flags for a user for an access level.

20. A transaction authorisation system as claimed in claim 19, wherein the role manager comprises means for combining the permission values with an excluded flag over-riding enabled flags.

21. (canceled)

22. A computer program product comprising software code for performing authorisation operations of an authorisation system of claim 1 when executing on a digital computer.
